(19) United States
(12) Patent Application Publication
(10) Pub. No.: US 2026/0126207 A1
(43) Pub. Date: May 7, 2026

(54) HUMIDIFYING AND FILTERING FLOOR REGISTER WITH CHILD-SAFE DESIGN FOR HVAC SYSTEMS

(71) Applicant: Platsun Inc., Ottawa (CA)

(72) Inventor: Johan VAN HULLE, Ottawa (CA)

(21) Appl. No.: 19/315,500

(22) Filed: Aug. 30, 2025

Related U.S. Application Data
(60) Provisional application No. 63/717,333, filed on Nov. 7, 2024.

(51) Int. Cl. F24F 13/08; B01D 46/00; F24F 6/00; F24F 6/04; F24F 8/125

(52) U.S. Cl. CPC F24F 13/085; B01D 46/0028; B01D 46/0038; F24F 6/04; F24F 8/125; B01D 2279/40; B01D 2279/65; F24F 2006/008

(57) ABSTRACT

The disclosure is a humidifying and filtering floor register for HVAC systems, designed to passively improve air quality as air flows through duct openings. It features a main body with a central water reservoir for optimal airflow, a filter to capture dust and allergens, and a top grille with an integrated funnel for easy refilling without removing the unit. Child-safe snap features secure the grille, and the design supports additional accessories like booster fans and sensors. This modular, low-maintenance solution enhances indoor air quality, benefiting homes with children and eco-conscious users.

### CROSS REFERENCE TO RELATED APPLICATIONS

The application claims priority to and the benefit of U.S. Provisional Patent Application Ser. No. 63/717,333, entitled “HUMIDIFYING AND FILTERING FLOOR REGISTER WITH CHILD-SAFE DESIGN FOR HVAC SYSTEMS”, filed on Nov. 7, 2024, of which is incorporated herein by reference in its entirety.

### BACKGROUND

Modern homes in North America are frequently heated and cooled using HVAC (Heating Ventilation and Air Conditioning) systems.

Many of these HVAC systems use a centralized forced air system to utilize the efficiency of central cooling and heating units. These systems use a network of ducting to distribute the heated or cooled air to different rooms of the household.

While some centralized HVAC systems have centralized systems to increase the humidity inside a house, they operate on the whole house at once, and are generally unable to add humidity to specific areas of a house that may require additional humidification.

Further, the current systems have only a centralized filter to trap dust and allergens, making per room filtration selection impossible.

### SUMMARY

The disclosure is a humidifying and filtering floor register for HVAC systems, designed to passively improve air quality as air flows through duct openings.

The disclosure features a main body with a central water reservoir permitting optimal airflow, a filter to capture dust and allergens, and a top grille with an integrated spout for easy refilling without removing the unit.

Child-safe snap features secure the grille, and the design supports additional accessories like booster fans and sensors.

This modular, low-maintenance solution enhances indoor air quality, benefiting homes with children and eco-conscious users.

### BRIEF DESCRIPTION OF THE DRAWINGS

FIG. 1 Is a perspective view of the floor register showing the top cover grille detached.

FIG. 2 is a cross-sectional side view of the vent register, showing the position of the central water reservoir within the duct.

FIG. 3 is a top-down perspective view of the floor register.

FIG. 4 is an exploded view of the unit showing top grille, the evaporating filter and the base with integrated reservoir.

FIG. 5 is a perspective view illustrating the top-refill function of the reservoir through the spout.

FIG. 6 is a cross-section highlighting the interaction between the water reservoir, the evaporator filter, and airflow.

FIG. 7 is a sectional side view showing the floor register installed above a booster fan accessory within the duct boot.

### DETAILED DESCRIPTION

In the following descriptions, the present disclosure will be explained with reference to various example embodiments; nevertheless, these embodiments are not intended to limit the present disclosure to any specific example, environment, application, or particular implementation described herein. Therefore, descriptions of these example embodiments are only provided for purpose of illustration rather than to limit the present disclosure. The disclosure is to cover all modifications, equivalents, and alternatives falling within the scope of the disclosure as defined by the appended claims.

The various features or aspects discussed herein can also be combined in additional combinations and embodiments, whether or not explicitly discussed herein, without departing from the scope of the disclosure.

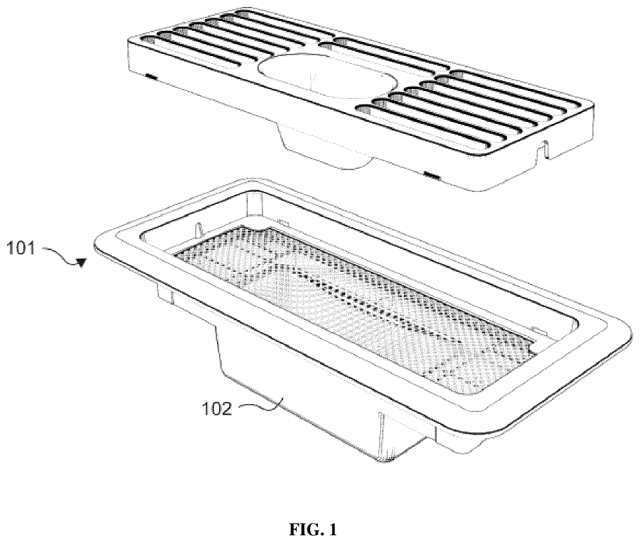

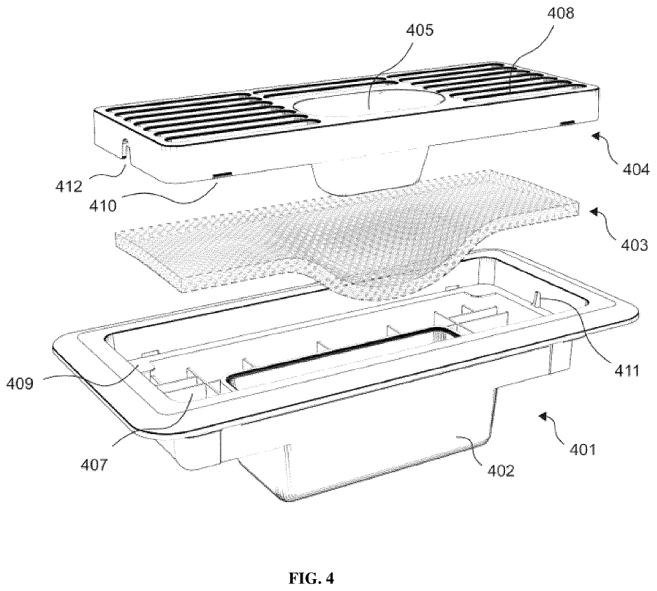

FIG. 1 shows a partially exploded view of the air duct humidifier and filter arrangement. The filter and floor insertable element 101 is shown. This element sits in the opening in the floor that is the air duct. Typically, the air flow is up from the bottom of the duct below the insertable element 101 and passes by the reservoir 102. The top grill and funnel component (shown as 404 in FIG. 4) sits in side the top cavity of element 101 and provides mechanical protection of both the reservoir and the filter, while permitting airflow.

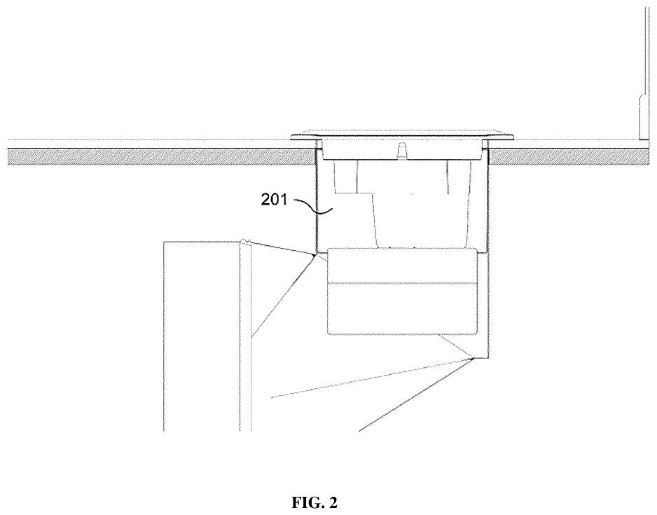

FIG. 2 shows an end view of the installed device inside an air duct cavity 201.

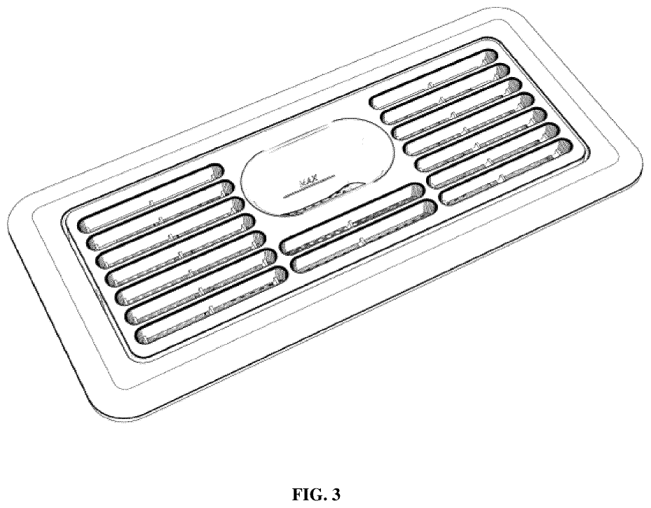

FIG. 3 shows a top isometric view of the top grill and funnel arrangement. An additional feature of this element is shown with the MAX line indicating the maximum water level to which the reservoir should be filled.

FIG. 4 is a partially exploded isometric view of the air duct humidifier and filter. The top grill and funnel is indicated as element 404 and the funnel is indicated as element 405 directing water to the center portion of the reservoir. Element 408 is the top grill system that provides for mechanical protection preventing large objects from entering the reservoir or duct system. The top grill is constructed with reinforcements to permit a larger weight, such as that of a person, to be supported without breaking. Additional features on the top grill 409 provide centering alignment so that the top grill does not move out of position with respect to the reservoir and filter 401. These alignment features mate with features 411 and similar features on the reservoir and filter 401. Further, elements 411 provide a retention mechanism to allow a screw to securely captivate the air duct humidifier and filter to the side of the air duct aperture.

The filter and wicking humidifier element 403 is designed with an indentation as shown in FIG. 4. This indentation is designed to extend the indented part of the wicking filter 403 into the reservoir 402. Preferably, the wicking filter is designed to have sufficient capillary action to keep the wicking filter wet while there is water in the reservoir. Additionally, the wicking filter should be sufficiently extended into the reservoir so as to have contact with the reservoir water at all times.

Similar alignment and retention features 410 and 409 provide a click-locking system. In one embodiment, the force to engage and disengage the tab and hole arrangement is sufficient to prevent a small child from removing the top grill, but not so much as to make disassembly for cleaning and maintenance by an adult difficult.

Elements 407 provide additional structural reinforcement for the assembly and support of the top grill. In addition, these elements direct air flow to create uniform distribution of air flow through various parts of the filter and wicking humidifier element 403.

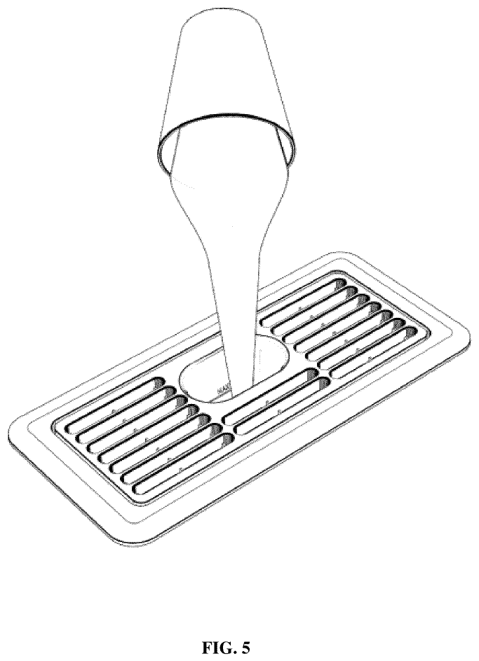

FIG. 5 shows a method whereby the reservoir can be filled with a container such as a drinking cup. Note that the funnel component of the top grill and funnel is directing water flow to the centre of the reservoir to avoid water leaking into the ducting.

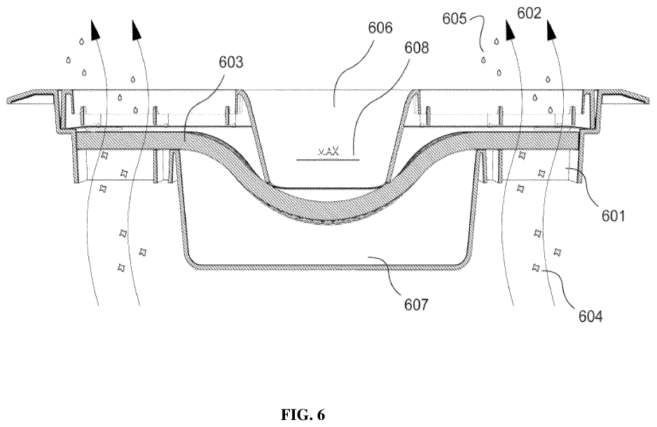

FIG. 6 is a front cutaway view of the assembly in operation. Untreated air 604 arrives through the ducting and is directed around the reservoir 607 through air channels 601. As the air flows through the filter and wicking humidifier element 603, the filter captures some of the particulate matter that is in the air. The air also picks up water from the wet humidifier element 605, and cleaned and humidified air is thus moved into the room 602.

The MAX indicator 608 indicates the maximum recommended water level that should be in the reservoir and is lower than the walls of the reservoir by a moderate safety margin. This indicator would be helpful to watch with respect to the water level when filling the reservoir via funnel 606.

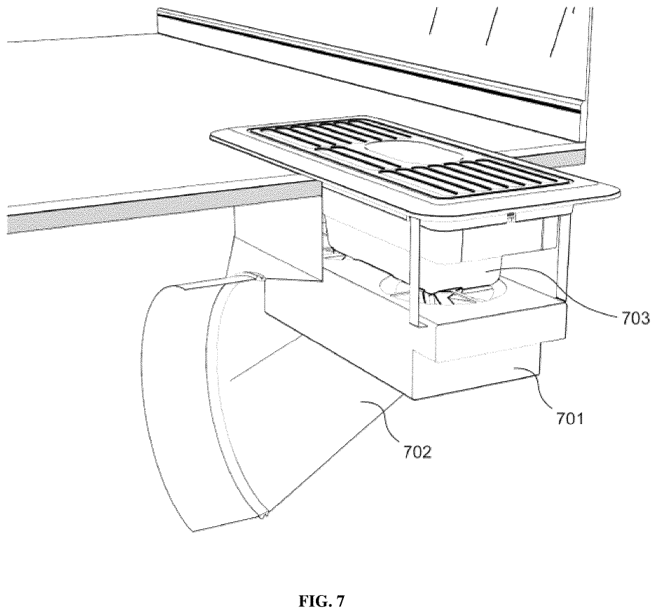

FIG. 7 shows an isometric view of an alternate embodiment where an additional assistive blower mechanism 701 is added to the assembly. The blower adds additional air pressure to enhance the airflow and to compensate for any loss of air pressure or flow that would be caused by the filter and wicking humidifier. In addition, some heating systems do not have centralized forced air 702, and 701 could be a combined local heating element with airflow provided entirely by 701. The heating/cooling element could be part of a hydronic system or an electrical heating element. In this embodiment, care must be taken to select materials that are compatible with any localized temperatures due to heating of the heating element. Element 703 is the reservoir, that necessarily produces some air flow restriction from the main air duct 702.

As illustrated in FIG. 2, the humidifying and filtering floor register is designed to fit seamlessly within standard HVAC duct openings 201, providing an integrated solution for passive humidification and air filtration.

As depicted in FIG. 4, The floor register consists of 3 key components. The main structural body or base 401 and water reservoir 402, the filter and evaporator medium 403 and the top grille 404 with integrated spout 405.

The primary structural body or base 101, as shown in FIG. 1, is configured to house a centrally located water reservoir 102. This water reservoir is sized to fit within the duct boot 201 while maintaining sufficient space for air to pass freely around it. The reservoir 102 has rounded edges, which help reduce turbulence and promote smooth airflow. The positioning of the reservoir is central but offset to one side of the unit. This is so that the base can be placed in the duct boot such that the reservoir leaves enough space near the duct opening for incoming air to find its way through the system. In some embodiments, the reservoir may be removable for ease of maintenance and refilling, while the base structure 401 remains secured within the duct boot. This feature may be useful for cleaning the duct or replacing components of the system.

The structural body has ribs 407 to provide strength in the vertical direction of the base. These ribs are oriented and positioned such that they provide strength to the base, without blocking and disrupting airflow. Additionally, the ribs provide a resting surface for the filter 403. In this same structural body, holes for mounting screws 411 are present on each side of the housing. This is a key child-proofing feature, as floor registers are often removed by children. The top grille has larger holes 412 in the same area to make space for the head of the screw once it is installed through the housing into the duct boot. Another advantage is that the structural housing can stay in place and the top cover grille 404 can be removed to access the filter medium 403 for maintenance.

The top cover grille 404 has two-way snap features 410 that allow the grille to be locked in place, while still making it possible to pull the cover out of the base by placing a hand in the top spout and pulling upwards. In another embodiment, these snap features could be 1-way, with a tab that needs to be engaged for these snap features to release and free the top cover from the base. Another embodiment would be a latch or slider that locks the top cover in the base. These locking features are important to protect children who would otherwise remove the cover and have access to the duct boot, which is unsanitary and unsafe.

The top cover grille 404 has openings arranged in a grille or vent pattern alongside a centrally located spout opening 405. This spout is shaped to allow for easy refilling from above, enabling the user to pour water directly into the reservoir without the need for dismantling the unit, as also depicted on FIG. 5. The wide-mouth opening 406 is designed to accommodate both pouring and manual removal of the spout for maintenance. The spout is also structured to deform the wick filter 407 into place when inserted, ensuring proper alignment for optimal water absorption. In some embodiments, the spout has an integrated cap that closes the top fill opening 405.

The filter medium 403, serves both as a humidifying medium and a dust filter. As depicted FIG. 6, which is a cross-sectional view of the system, the filter medium is designed to use capillary action to draw water from the reservoir until it is fully saturated with water. The filter is positioned below the ribs of the top grille 408 and above the ribs of the base 407 on which it rests. Additionally, the base has features 409 in the corner areas, which additionally trap the filter so that it is held in the correct position, ensuring no gaps in which airflow can bypass the filter. These features 409 could be simple tabs that protrude out of the housing, providing friction between the housing and filter to hold it in place. In some embodiments these tabs could have snaps, ridges, or bosses which will penetrate the filter so that the filter is even more secured. The filter may also have a rigid or semi-rigid border, that may be made out of cardboard, metal, plastic or rubber, which also interacts with these features to ensure a good seal and positioning.

The spout 606 which is part of the top grille, helps the flow of water from the top into the reservoir 607. The spout also deforms the filter such that it reaches into the reservoir and comes into contact with the water once this reservoir is filled in a manner as shown on FIG. 5. A line indicating the maximum water level 608 may be present on the inside of the spout. The filter medium is positioned over the open sections of the base unit 601 which are located around the reservoir. This places the wet filter into the airflow, passively humidifying the air that passes through the register 602. In some embodiments, the filter 603 is a single layered flat filter or three-dimensional wick filter, constructed from absorbent materials such as non-woven fibres, wood pulp or even advanced materials such as nano-fibre meshes or superabsorbent polymers or ceramic materials. In another embodiment, this filter medium is a composite of two or more layers, each layer specialised in either filtering dust or absorbing water, where one layer of the filter could be made out of fibreglass or a polymer such as polypropylene, arranged into fibres woven together into a single flat sheet or as multiple layers arranged in three-dimensional structures, or wick structure, to improve surface area and elasticity in multiple planes. This embodiment of composite filter may also have an open section where the reservoir is, where only the absorbent part of the filter is present, as there would be no need for dust filtering in that area because the reservoir is not in the path of the airflow.

The filter may also include strategic cuts or folds to ensure it conforms to the reservoir's shape, thereby optimizing its surface area for maximum evaporative effect. The filter 603 is securely placed within the register, as shown in FIG. 6, ensuring that air cannot bypass the humidifying and filtering process. Once the moving air passes the filter and evaporator medium 603, dust, hair pollen and other allergens 604 get trapped and the humidity of the water saturated filter gets passed on to the moving air from the HVAC system, thus humidifying the air 605.

In some implementations, the system is designed to work in conjunction with other duct accessories, such as booster fans, sensors, catching nets or filter pads, as illustrated in FIG. 7. The geometry and size of the base is chosen such that the larger of the accessories, which are typically booster fans 701, will fit together in the duct boot 702. The integration of these components further enhances the system's ability to circulate clean, humidified air throughout the room. In certain embodiments, holes may be provided in the structural body to accommodate electrical wiring or other accessory cables, ensuring that the system remains flush with the floor while maintaining functionality. Another method of integrated the cable or wiring into this combination system, would be a separate border that has an opening for the cable. This border piece would then be placed under the floor register so that it sits higher than the floor. This new height would allow the cable to pass through the opening while keeping the floor register parallel to the floor.

In some implementations, the booster fans can detect the airflow from the HVAC system using airflow sensors, to automatically switch on when the system is running, and switch off when the HVAC system is not running. This way these electronic accessories are independent from any other trigger system required, such as an app or manual switch. To ensure electronic safety, these accessories are waterproof from the top side, where they would sit just below the reservoir of the floor register 703.

The filter element 403 could be made of a large number of materials selected for wicking (capillary action, to transport water from the reservoir to the entire filter and wicking humidifier element). In addition, selecting a material, thickness, and properties that provide helpful air filtration is desired. The filter element can be either disposable or cleanable and re-useable. One example of a suitable filter and wicking material is sustainable wood pulp. The filter element can be sold in different humidification intensities by selling different humidification elements that provide more or less humidification to the room. Similarly, different grades of filter could be used that provide more or less filtration, for example HEPA, PM 2.5 or lower filtration options. The filters can be integral to the filter element, or the filter and the humidification element could be purchased separately and stacked, providing a wide range of options with a minimal inventory. The filter element may also have a supportive frame that assists in placing and holding the filter element above the reservoir.

Another possible enhancement would be to provide a blocking damper to change airflow from a section of the device with the filtration and humidification element, to a portion of the device that does not have such humidification, giving more precise control over the humification in the room.

Another useful feature would be to provide a level indicator that is coupled to a float in the reservoir to inform a person when the reservoir is nearing or has reached an empty state. This could be a simple mechanical indicator coupled to a float inside the reservoir.

A similar indicator could be attached to the device that measures a combination of time and/or air flow through a commercially available air flow sensor, and indicates when the filter is likely to need changing or cleaning.

While the word ‘water’ is used throughout this document to indicate a universal, popular, and inexpensive humidification fluid, the fluid added to the reservoir may have one or more additives or substitutions including elements to enhance the smell of the airflow, to impede growth of bacteria, mould or the like, or to provide a more controlled release of humidity into the airflow. A further variation could allow for a detachable reservoir element to allow for easier periodic deeper cleaning.

According to the disclosure, a humidifying and filtering floor register apparatus that provides a room with additional air filtration. The apparatus comprises a frame, a water reservoir; a filter; and a wicking humidifier element. The the filter and wicking humidifier element is in proximity to the water reservoir such that when the water reservoir is at a sufficient fullness and the water in the water reservoir wets the filter and wicking humidifier element;

According to the disclosure, airflow passing through parts of the filter and wicking humidifier element are exposed to the filter and wicking humidifier element and add humidity in the airflow. The filter and wicking humidifier element is configured to filter and trap contaminants in the airflow. The floor register further comprises a grill and a funnel to aid in directing water to the reservoir for refilling.

According to the disclosure, at least part of the floor register is configured to fix the register securely to the side of the floor register opening. The funnel feature is further configured for deformation of the filter and wicking humidifier element into the water reservoir.

According to the disclosure, the funnel element is equipped with an indicator showing the maximum level of water that can safely be added to the reservoir. The floor register apparatus incorporates air flow controls to direct the air flow between a humidified section of the floor register and a section that is not humidified.

According to the disclosure, the wicking filters are available providing filtration. The air flow is directed by a plurality of directing elements to different portions of the wicking filter. The wicking filters are available in different humidification intensities.

According to the disclosure, the top register grate element of the floor register clicks in place to prevent children from opening the register grate. Additional additives can be used in the reservoir to enhance the smell of the airflow, to impede growth of bacteria, mould, or to provide a more controlled release of humidity into the airflow.

According to the disclosure, the floor register apparatus further comprises a booster fan to increase airflow through the floor register. Furthermore, the floor register apparatus further comprising an additional or standalone heating or cooling element or sensor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A humidifying and filtering floor register apparatus that provides a room with additional air filtration, the apparatus comprising:
a frame;
a water reservoir;
a filter; and
a wicking humidifier element;
wherein the filter and wicking humidifier element is in proximity to the water reservoir such that when the water reservoir is at a sufficient fullness;
wherein the water in the water reservoir wets the filter and wicking humidifier element;
wherein airflow passing through parts of the filter and wicking humidifier element are exposed to the filter and wicking humidifier element and add humidity in the airflow.

2. The floor register apparatus of claim 1 wherein the filter and wicking humidifier element is configured to filter and trap contaminants in the airflow.

3. The floor register apparatus of claim 1 further comprises a grill and a funnel to aid in directing water to the reservoir for refilling.

4. The floor register apparatus of claim 1 wherein at least part of the floor register is configured to fix the register securely to the side of the floor register opening.

5. The floor register apparatus of claim 1, whereby the funnel feature is further configured for deformation of the filter and wicking humidifier element into the water reservoir.

6. The floor register apparatus of claim 1 whereby the funnel element is equipped with an indicator showing the maximum level of water that can safely be added to the reservoir.

7. The floor register apparatus of claim 1 incorporates air flow controls to direct the air flow between a humidified section of the floor register and a section that is not humidified.

8. The floor register apparatus of claim 1 whereby the wicking filters are available providing filtration.

9. The floor register apparatus of claim 1 whereby the air flow is directed by a plurality of directing elements to different portions of the wicking filter.

10. The floor register apparatus of claim 1 whereby the wicking filters are available in different humidification intensities.

11. The floor register apparatus of claim 1 whereby the top register grate element clicks in place to prevent children from opening the register grate.

12. The floor register apparatus of claim 1 whereby additional additives can be used in the reservoir to enhance the smell of the airflow, to impede growth of bacteria, mould, or to provide a more controlled release of humidity into the airflow.

13. The floor register apparatus of claim 1 further comprising a booster fan to increase airflow through the floor register.

14. The floor register apparatus of claim 1 further comprising an additional or standalone heating or cooling element or sensor.
